(19) United States
(12) Patent Application Publication
(10) Pub. No.: US 2003/0100629 A1
(43) Pub. Date: May 29, 2003

(54) Powdered pencil II

(76) Inventors: Reiner Appel, Oberascbach (DE); Gerhard Lugert, Nurnberg (DE)

Correspondence Address: VENABLE, BAETJER, HOWARD AND CIVILETTI, LLP, P.O. BOX 34385, WASHINGTON, DC, 20043-9998, US

(21) Appl. No.: 10/327,073

(22) Filed: Dec. 24, 2002

Related U.S. Application Data
(63) Continuation-in-part of application No. 10/238,881, filed on Sep. 11, 2002.

(30) Foreign Application Priority Data
Sep. 11, 2001 (DE) 101 44 532.6

(51) Int. Cl. C09D 13/00

(52) U.S. Cl. 523/164

(57) ABSTRACT

The invention relates to a colored lead or a colored chalk with a porous basic lead body, the primary components of which are a filler material and a non-ionic associative thickener, wherein the cavities in the porous basic lead body are filled with a solid or liquid phase.

### CROSS-REFERENCE TO RELATED APPLICATION

This application is a continuation of U.S. application Ser. No. 10/238,881, filed Sep. 11, 2002, and claims the priority of German Patent Application No. 101 44 532.6 filed Sep. 11, 2001. The disclosures both foregoing applications are hereby incorporated herein by reference.

### BACKGROUND OF THE INVENTION

The invention relates to a colored lead or a colored chalk used for cosmetic purposes or for applying to drawing backgrounds, such as paper or the like. Colored leads containing cellulose derivatives as binders (Ullmann's Encyclopedia of Industrial Chemistry, VCH Verlagsgesellschaft mbH [Publisher], D-6940 Weinheim, 1987, page 39) are known. These leads are produced by mixing binder, filler materials, pigments and, if necessary, additives with water and by squeezing out or extruding the resulting mass, so as to form ropes. The ropes are subsequently cut to length to form leads and these are dried at approximately 100° C. Basic lead bodies obtained in this way are then dipped into a fat or wax bath. The known leads have a relatively solid, compact structure and contain only a limited number of cavities, so that only between 10 and 25 weight percent of the lead can absorb wax or fat. A further disadvantage is the fact that the cavities in the lead cannot be filled with an aqueous phase. The application behavior or release behavior of the known leads is primarily determined by the oil/wax/fat mixture. For cosmetic applications, oily or fatty marks of this type are often viewed as unpleasant. Even more unpleasant is the fact that for the mark application, the lead must be guided with relatively high pressure across the skin. For application on paper, the lead often creates a smudgy or sticky stroke with weak color, independent of the respective application. In addition, the known leads have only low temperature stability.

In view of these problems, it is the object of the invention to provide improved leads having an alternative composition, in particular with respect to their stroke behavior.

### SUMMARY OF THE INVENTION

This object is achieved with a lead having a porous basic lead body. The lead contains a filler material and a non-ionic associative thickener as main forming components. Surprisingly, it was discovered that when using these types of thickeners, porous basic lead bodies can be produced that have increased cavity volume compared to traditional leads and are comparable to powder leads with respect to consistency and stroke behavior. The aforementioned thickeners consist essentially of polymers with a hydrophilic backbone into which hydrophobic areas and/or molecule groups are embedded. The hydrophobic areas and/or molecule groups are capable of attachment to each other as well as to hydrophobic groups of other molecules or to hydrophobic filler material particles. Thus, they have a thickening and/or strengthening effect by forming a hydrophobic network. In contrast, the hydrophilic areas primarily react with water and with hydrophilic additives, chiefly with hydrophilic filler material particles. Thus, the consistency of the finished lead can vary over a broad range, depending on the additives selected.

On one hand, the suggested thickeners surprisingly exhibit binder characteristics and, on the other hand, they can be used to facilitate the production of porous basic lead bodies. These leads have a cavity volume that is approximately twice that of known leads having binders based on cellulose derivatives. It is emphasized in particular that the lead mass does not shrink during the drying process. In contrast, traditional leads with binders on a based on cellulose derivatives exhibit noticeable shrinkage that must be compensated for by increasing the size of the extruded lead ropes.

An associative thickener that contains a copolymer of at least one polyoxyethyleneglycol polymer (PEG) with 5 to 300 CH₂—CH₂—O-monomers and n-alkoxy-alkylglycouril-monomers is preferably used. Especially preferred is the use of a copolymer with tetramethoxy-methylglycouril-monomers. The best results are achieved with a copolymer of PEG-180 (q.v.), dodoxynol-5 (q.v.), PEG-25 tristyrylphenol and tetramethoxymethylglycouril-monomers. According to the INCI nomenclature, this material is called “Polyether-1.” (The user specification q.v. stands for “quantity varies.”)

During the production of a basic lead body, the associative thickener and the filler materials as primary components are mixed with water and the mixture is then extruded in the form of ropes that are cut to length. The basic lead bodies of the invention have the special advantage of having a porous and powdery consistency following extrusion and cutting that is completely different from traditional leads. In addition, they have clearly higher flexibility and fracture strength when wet, which facilitates handling during the production, and, accordingly, also results in soft stroke behavior.

It is furthermore advantageous that while still wet the basic lead bodies of the invention can be further processed in three different ways into products with different characteristics. To obtain leads with a powdery consistency, the leads are dried and the initially-added water is removed. Porous basic lead bodies created in this way have a large cavity volume and a stroke behavior known from powder leads. In a second variant, the cavities, which can amount up to 45% of the total volume, can be saturated optionally with a liquid phase or a phase that is liquefied through heating, e.g. with waxes, fats, oils or other substances, e.g. substances having skin-care characteristics. Leads obtained in this way have a broad spectrum of characteristics, particularly with respect to their stroke behavior. Finally, the extruded lead pieces can also be used without further treatment as cosmetic leads with a high water content. These have a cooling effect caused by the evaporation of water during application. The particular advantage of these leads, as well as the water-free leads, is that the removal of water does not lead to shrinkage. Thus, the water-containing leads can be provided with an enclosing material, for example a wooden shell, without losing their fixed seat inside the shell if a portion of the water evaporates or is absorbed by the shell. It is also advantageous that the above-mentioned starting mixture can be extruded or squeezed out easily.

The proposed leads furthermore have the advantage that the associative thickener used during the production also has emulsifying characteristics in addition to an extremely strong thickening effect. The associative thickener is able to bind a large amount of filler materials, which is attributed to a reciprocal action between the filler material particles and the thickener molecules, particularly with their hydrophobic groups. In this process, the effect causing the thickening and/or solidification of the basic lead bodies and thus the consistency of the finished lead can be controlled by purposeful selection of filler materials or other additives.

The parameters of flexibility and fracture strength, which are most important during the production process, can be increased if necessary by adding a small amount of organic binder, e.g. sodium alginate, without reducing the soft consistency, good applicability and ability to sharpen the leads. Polymethyl methacrylates, mica and silica are most suitable as powdery filler materials. Of course, other filler materials are possible as well. Wetting means such as disodium-laureth-sulfosuccinate (INCI name) are suitable as auxiliary materials for extruding the starting mass and to promote adhesion. Small amounts (<10%) of waxes, fats, oils (e.g. castor oil) or emulsifiers can be added to improve the sliding ability during the application and to improve the adhesive strength of the powder, as well as to reduce the formation of cracks in the leads during the drying process. Hydrogenated palm kernel glycerides/hydrogenated palm glycerides are primarily mentioned in this connection. If necessary, skin-care substances such as lanolin, aloe vera, tocopherol and others, as well as preserving agents or aromatic substances can also be added. In principle, all additives and auxiliary agents not required to be present at the start of the process can be worked into the cavities of the basic lead bodies following the drying process by dipping these into a corresponding liquid. Materials that are solid at the application temperature (approximately 0 to 45° C.), e.g. fats, are liquefied by heating them. With water-containing preparations, it is possible in principle to saturate a dried basic lead body with water. However, it is preferable to add the amount of water desired for the finished lead when mixing together the starting materials. In that case, finished leads are obtained after extrusion and cutting.

Some advantages of the lead according to the invention are summarized as follows:

In contrast to traditional poured or extruded cosmetic leads, soft application leads for cosmetic applications can be produced with improved release characteristics and with an easier production method that results in fewer lead body rejections.

Unlike traditional wax leads, the leads of the invention are stable or usable even at temperatures of 50° C. and above.

Depending on the proportion of waxes, fats or oils, the leads according to the invention are more or less water-resistant. Through the admixture of an emulsifier, the leads become water-soluble or can be used as watercolors.

By adding skin-care substances such as aloe, lanolin, lavender oil or aromatic substances and/or perfumes or vitamins, e.g. tocopherol, or volatile substances such as silicon oil, leads or chalks containing water as well as oil, wax, fat or emulsifiers can furthermore meet one or several additional functions. The addition of W/o (water-in-oil) or O/W (oil-in-water) emulsions or plastic dispersions is also possible. The above-mentioned substances can furthermore be micro-encapsulated either completely or in part.

Exemplary Embodiments:

In one embodiment, the existing cavities can be filled with a large quantity of water or with aqueous formulations, which can also contain skin-care substances or even aromatic agents, for example in micro-encapsulated form. Pencil strokes produced with these leads have a cooling effect, caused by the evaporation of water during the application to the skin.

In another embodiment, the existing lead cavities can be filled with oils, waxes, fatty acid derivatives, fats or emulsifiers and even mixtures thereof, wherein these additives preferably amount to a total proportion of 20-45%. Examples of such oils are castor oil, palm oil and paraffin oil. Examples of waxy substances include microcrystalline waxes, hydrated castor oil, bees wax, carnauba wax, berry wax, candelilla wax, paraffin wax or hydrogenated palm kernel glycerides, hydrogenated palm glycerides, polyethylene waxes and Japan wax. Examples of fatty acid derivatives are stearic acid, palmitic acid, oleic acid and fatty alcohols or esters of fatty alcohols, such as cetyl octanolate.

Leads or Chalks with Cavities Containing Watery Preparations

Filler materials, pigments, thickening agents as well as other possible additives are mixed homogeneously in a kneader or rapid mixer. Water or an aqueous preparation is worked into the existing mixture. Following that, the mass is extruded to form lead pieces which, while still in the wet condition, are inserted directly into plastic tubes or holders or are provided with a wooden shell, possibly even surrounded with a heat-shrinkable plastic tube.

### EXAMPLE 1

A red colored chalk with increased water content; diameter 10 mm.

| | |
|---|---|
| polyether-1 (Pure Thix ® TX-1442, SÜD-CHEMIE) | 1.8% |
| mica | 17.0% |
| polymethylmethacrylate | 34.0% |
| disodium-laureth-sulfosuccinate | 3.0% |
| (CAS 68 815-56-5) | |
| hydrogenated palm kernel glycerides, | 2.4% |
| hydrogenated palm glycerides | |
| (CAS 67 701-26-2) | |
| P.R. 112 CI 12 370 | 6.0% |
| water | 35.5% |
| preserving agents | 0.3% |

Polyether-1 is commercially available from the company SÜD-CHEMIE AG under the tradename Pure Thix® TX-1442.

The chalk strokes can be turned into watercolor strokes.

### EXAMPLE 2

A black colored chalk with increased water content and a plastic dispersion; diameter 12 mm.

| | |
|---|---|
| polyether-1 | 1.8% |
| mica | 12.0% |
| polymethylmethacrylate | 24.0% |
| disodium-laureth-sulfosuccinate | 1.2% |
| (CAS 68 815-56-5) | |
| black rouge (iron (II, III) oxide) | 18.0% |
| CI 77 499 | |
| watery polyurethane dispersion; | 10.0% |
| 60% solid matter | |
| water | 32.5% |
| preserving agents | 0.5% |

A watery polyurethane dispersion of the type as used is commercially available under the tradename U210 from the company Alberdingk Boley GmbH in Germany or the company Alberdingk Boley Inc. in the United States.

As compared to Example 1, the dried on chalk strokes have a reduced watercolor ability.

### EXAMPLE 3

A black lead with increased water content for cosmetic applications, e.g. an eyeliner; diameter 4.0 mm.

| | |
|---|---|
| polyether-1 | 1.8% |
| sodium alginate (E 401) | 0.2% |
| mica 97-99%; silica 1-3% | 17.0% |
| (CAS 12 001-26-2, 7 631-86-9) | |
| polymethylmethacrylate | 24.0% |
| disodium-laureth-sulfosuccinate | 3.0% |
| (CAS 68 815-56-5) | |
| hydrogenated palm kernel glycerides, | 1.6% |
| hydrogenated palm glycerides | |
| (CAS 67 701-26-2) | |
| black rouge CI 77 499 | 18.0% |
| water | 40.0% |
| preserving agents | 0.4% |

### EXAMPLE 4

A yellow lead for cosmetic applications, containing water and micro-encapsulated dispersion with aromatic substance; diameter 8 mm.

| | |
|---|---|
| polyether-1 | 1.8% |
| methyl cellulose | 0.3% |
| mica 97-99%, silica 1-3% | 12.0% |
| (CAS 12 001-26-2, 7 631-86-9) | |
| talcum | 20.0% |
| magnesium myristate | 4.0% |
| disodium-laureth-sulfosuccinate | 3.0% |
| (CAS 68 815-56-5) | |
| hydrogenated palm kernel glycerides, | 1.6% |
| hydrogenated palm glycerides | |
| (CAS 67 701-26-2) | |
| titanium dioxide CI 77 891 | 10.0% |
| iron oxide yellow CI 77 492-77 491 | 8.0% |
| special aromatic substance MRD “Blue Line” | 30.0% |
| (Bayer AG) | |
| polyurethane encapsulated parfume; 50% watery | |
| dispersion with capsule size 6 microns | |
| water | 8.8% |
| preserving agents | 0.5% |

The powdery raw materials together with the water are mixed at high speed in a rapid mixer. The micro-encapsulated perfume dispersion is stirred in by stirring it slightly. The perfume is released when the cosmetic mass is applied to the human skin and distributed with the finger.

Leads or Chalks with Cavities Containing Waxy or Oily Preparations

Filler materials, pigments, thickeners as well as other possible admixtures are mixed homogeneously in a kneader or rapid mixer. Water or a watery preparation is worked in the existing mixture. Following that, the mass is correspondingly extruded, cut into leads or chalk pieces and dried at a moderate temperature (20-70° C.). The pieces are then submerged into an oil and/or wax and/or fat and/or emulsifier mixture (impregnation), wherein this mixture can be liquid at room temperature or can be liquefied at an increased temperature (as a rule max. 130° C.). The leads are used for wood-enclosed or plastic enclosed products or can be marketed in the form of chalks, with a diameter >4 mm.

### EXAMPLE 5

A red colored chalk with a water-soluble, waxy substance (emulsifier); diameter 8 mm.

| Raw material/basic lead body: | |
|---|---|
| polyether-1 | 2.0% |
| mica | 17.0% |
| polymethylmethacrylate | 34.0% |
| disodium-laureth-sulfosuccinate | 3.0% |
| (CAS 68 815-56-5) | |
| hydrogenated palm kernel glycerides, | 2.7% |
| hydrogenated palm glycerides | |
| (CAS 67 701-26-2) | |
| P.R. 112 CI 12 370 | 6.0% |

Impregnation:

Crodet S100 veg. [CAS 9004-99-3]; following submersion of the chalk, the emulsifier absorption is approximately 35%.

Crodet S100 veg., a PEG-100 stearate, is a product of the company Croda

Chemicals Ltd., UK.

The chalk marks have the appearance of watercolors.

### EXAMPLE 6

A blue colored lead for cosmetic purposes (e.g. eye shadow) with a diameter of 6 mm and containing a water-resistant, waxy mixture.

| Raw material/basic lead body: | |
|---|---|
| polyether-1 | 1.8% |
| sodium alginate (E 401) | 0.1% |
| mica 97-99%, silica | 1-3% |
| (CAS 12 001-26-2; 7 631-86-9) | 12.0% |
| polymethylmethacrylate | 24.0% |
| disodium-laureth-sulfosuccinate | 3.0% |
| (CAS 68 815-56-5) | |
| hydrogenated palm kernel glycerides, | 1.6% |
| hydrogenated palm glycerides | |
| (CAS 67 701-26-2) | |
| pigment | 18.0% |
| preserving agent | 0.4% |

impregnation solution: approximately 40.0%

Composition of the Impregnation Solution:

| | |
|---|---|
| cetyl octanoate | 40% |
| 100 sucrose acetate isobutyrat | 40% |
| [CAS 000126-13-16] | |
| candelilla wax | 7% |
| carnauba wax | 7% |
| bees wax | 6% |

All percentages provided are weight percentages unless otherwise specified.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. Colored lead or colored chalk, having a porous basic lead body comprising a filler material and a non-ionic associative thickener as primary components, wherein basic lead body cavities are filled with a solid or liquid phase.

2. Colored lead or colored chalk according to claim 1 wherein
the associative thickener comprises a copolymer of at least one polyoxy-ethyleneglycol polymer (PEG) with 5 to 300 CH₂—CH₂—O-monomers and n-alkoxy-alkylglycouril monomers.

3. Colored lead or colored chalk according to claim 1, wherein the copolymer comprises tetramethoxy-methylglycouril monomers.

4. Colored lead or colored chalk according to claim 3 wherein the copolymer comprises PEG-180 (q.v.), dodoxynol-5 (q.v.), PEG-25-tristyrylphenol and tetramethoxy-methylglycouril monomers.

5. Colored lead or colored chalk according to claim 1 that comprises an organic binder.

6. Colored lead or colored chalk according to claim 5 wherein said binder is sodium alginate.

7. Colored lead or colored chalk according to claim 1 wherein the filler material comprises polymethylmethacrylate particles.

8. Colored lead or colored chalk according to claim 1 wherein the filler material comprises mica.

9. Colored lead or colored chalk according to claim 1 that comprises a wetting agent.

10. Colored lead or colored chalk according to claim 9 wherein the wetting agent comprises disodium-laureth-sulfosuccinate.

11. Colored lead or colored chalk according to claim 1 comprising at least one component selected from the group consisting of oils, waxes, fats, fatty acid derivatives and water-soluble emulsifiers.

12. Colored lead or colored chalk according to claim 1 wherein the portion of the solid or the liquid phase filling the cavities is 20 to 45%.

13. Colored lead or colored chalk according to claim 12 comprising at least one component selected from the group consisting of water or watery preparations, oils, waxes, fats, fatty acid derivatives and emulsifiers as solid or liquid phase.

14. Colored lead or colored chalk according to claim 13 comprising a fatty acid derivative selected from the group consisting of hydrogenated palm kernel glycerides and hydrogenated palm glycerides.

15. Colored lead or colored chalk according to claim 1 that contains pigments as coloring agents.

16. Colored lead or colored chalk according to claim 1 with the following composition:

| Basic lead body: | |
|---|---|
| copolymer or associative thickener | 0.1-3% |
| organic binder | 0-5% |
| filler materials | 24-60% |
| wetting agents | 0-6% |
| wax and/or fat and/or fatty acid derivative and/or | 0-6% |
| emulsifier | |
| coloring agent | 0-30% |
| additive (e.g. aromatic agents, perfumes, | 0-15% |
| preserving agents, skin-care substances | |
| (optionally also micro-encapsulated)) | |
| Solid/liquid phase in the cavities: | |
| water or watery preparation or oils and/or waxes | 20-45% |
| and/or fats and/or emulsifiers | |

17. Colored lead or colored chalk according to claim 1 that additionally comprises at least one additive selected from the group consisting of aromatic agents, perfumes and skin-care substances in a micro-encapsulated form.

18. Colored lead or colored chalk according to claim 1 that comprises volatile silicon oils.
